(19) United States
(12) Patent Application Publication
(10) Pub. No.: US 2007/0086034 A1
(43) Pub. Date: Apr. 19, 2007

(54) System and method for updating the test print page of a printer driver of an information handling system

(75) Inventors: Charles G. Morton III, Leander, TX (US); Tiffany J. Williams, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/252,069

(22) Filed: Oct. 17, 2005

(51) Int. Cl. G06F 3/12

(52) U.S. Cl. 358/1.13

(57) ABSTRACT

A system and method is disclosed for updating the test print page of a computer system. The test print page is saved to nonvolatile memory and is accessible by the printer driver of the computer system. The test print page includes areas of content that are modifiable. The computer system may receive updated content for the test print page from a remote server, and the computer system may replace the existing content of the test print page with the updated content received from the remote server. The update content may include content reflect new product offerings.

### TECHNICAL FIELD

The present disclosure relates generally to computer systems and information handling systems, and, more particularly, to a system and method for filtering communications received at a network interface controller.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

An information handling system or computer system may include static bitmap file that serves as test print page for any printer that is connected to the information handling system. When the printing of a test print page is initiated, the printer driver prints the test print page. The test print page may be included in the printer driver or the test print page may be logically separate from the printer driver. The test print page, however, is static. Thus, the content of the test print page does not change over time. From the time that the computer system is shipped to a customer, the content of the test print page does not change.

### SUMMARY

In accordance with the present disclosure, a system and method is disclosed for updating the test print page of a computer system. The test print page is saved to nonvolatile memory and is accessible by the printer driver of the computer system. The test print page includes areas of content that are modifiable. The computer system may receive updated content for the test print page from a remote server, and the computer system may replace the existing content of the test print page with the updated content received from the remote server. The update content may include content reflect new product offerings.

The system and method disclosed herein is technically advantageous because it provides a method for dynamically updating the content of a test print page so that the test print page includes at least some content that is current and meaningful to either the user or the manufacturer of the computer system. The ability to update the test print page of the computer system provides for updating a test print page through the use dynamic content so that the test print page includes both static content, which cannot be updated, and dynamic content, which can be updated.

Another technical advantage of the system and method disclosed herein is that the updating of the test print page is done independently of the printer driver. Thus, if the printer driver is updated or reinstalled, the content of the test print page is not altered. Another technical advantage of the test print page disclosed herein is the dynamic content of the test print page can be divided into multiple areas of dynamic content, each of which can be updated independently of the others. In addition, the updates can be provided as HTML images, allowing the updated content to be easily transferred to the computer system and easily installed by the computer system in the test print page. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a computer system and the communications link between the computer system and a remote server computer;

FIG. 2 is an example of a test print page; and

FIG. 3 is a flow diagram of a method for updating the test print page.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

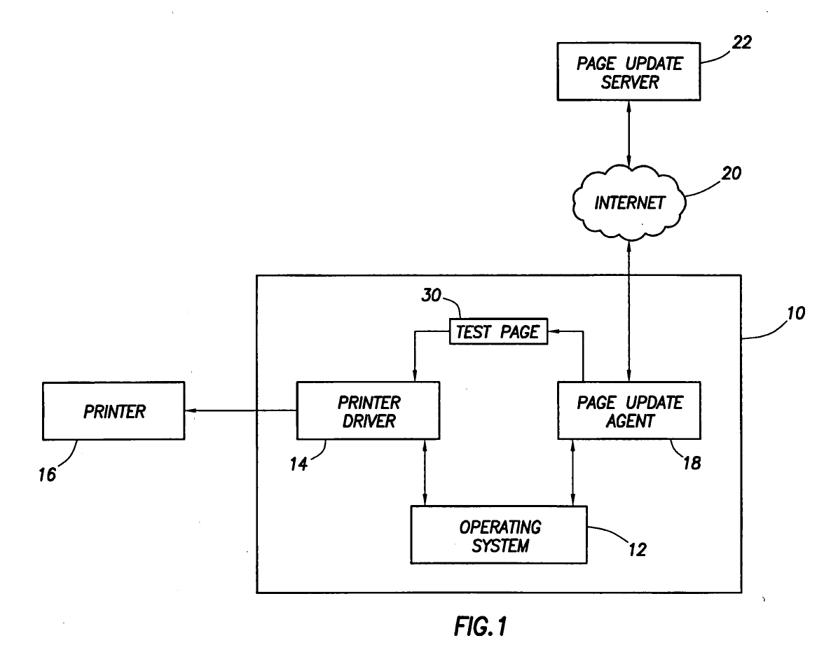

One example of an information handling system is a computer system. Shown in FIG. 1 is a diagram of a computer system and the communications link between the computer system and a remote server computer. Computer system 10 includes an operating system 12. Operating system 12 supports a printer driver 14 and a page update agent 18. Printer driver 14 is a software interface between computer system 10 and a printer 16. Printer driver 14 translates images to a data format that is expected by printer 16. Page update agent 18 is a software program that operates in the background of the computer system to monitor the status of various components of the computer system, including the status of the ink cartridge of printer 16. Also included in computer system 10 is a test print page 17. Test print page is saved to a non-volatile memory location in the computer system. Page update agent also updates the content of test print page 17. Test print page 17 is separate from printer driver 14. In this manner, if printer driver 14 is ever updated or reinstalled, test print page 17 will not be affected.

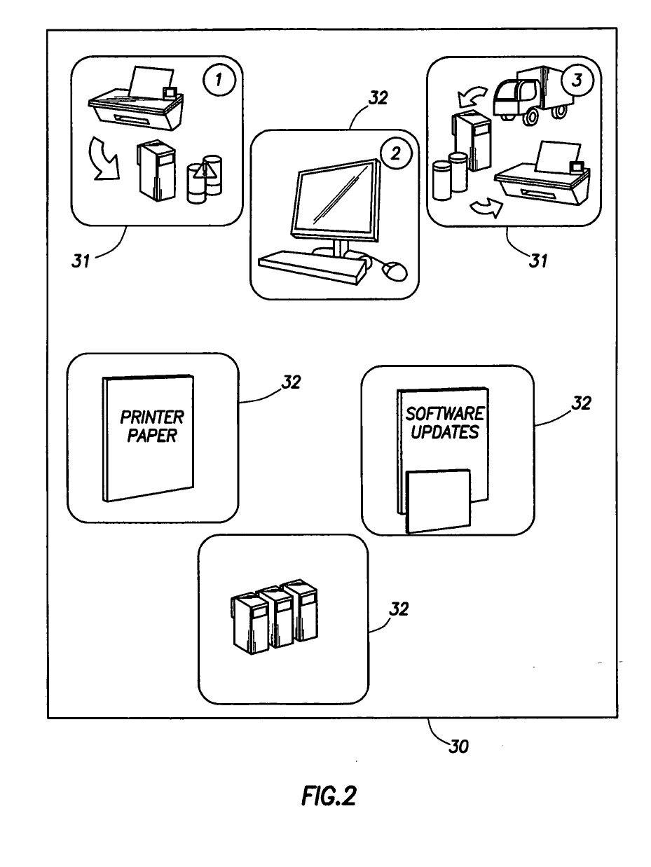

An example test print page 30 is shown in FIG. 2. The example test print page 30 of FIG. 2 includes static content 31 and areas 32 can be updated. Static content areas 31 include content that cannot be changed. For example, static areas 31 of FIG. 2 include instructions for ordering printer cartridges, and the manufacturer of the computer system does not wish for these areas to be modified. Areas 32 are dynamic or modifiable in that these areas can be updated by the page update agent. Dynamic areas 32 include content that can or should be updated over time. In the example of FIG. 2, dynamic areas 32 include information concerning recent product offerings of the computer manufacturer. Dynamic areas 32 may be populated by HTML images that can be easily replaced to complete the test print page. If the test print page includes multiple areas of dynamic content, each area is referred to herein as a slice of the test print page. If each area is an HTML image, the areas of dynamic content can be referred to as HTML slices of dynamic content.

Page update agent 18 can access page update server 22 through a communications network. In the example of FIG. 1, the communications network is Internet connection 20. In the configuration of FIG. 1, page update server 22 is located remotely from computer system 10. Page update agent 18 provides data concerning the computer system to page update server 22. This data includes the configuration of the computer system, the identification of peripheral components connected to the computer system, and the status of consumable products within or coupled to the computer system, such as the ink cartridge of the printer of the computer system. On the basis of the data provided by the page update agent, or on the basis of product and customer information accessible by the page update server 22, the page update server will provide updated content for the dynamic areas 32 of the test print page. It is not necessary that the page update server and the page update agent communicate to one another through the Internet.

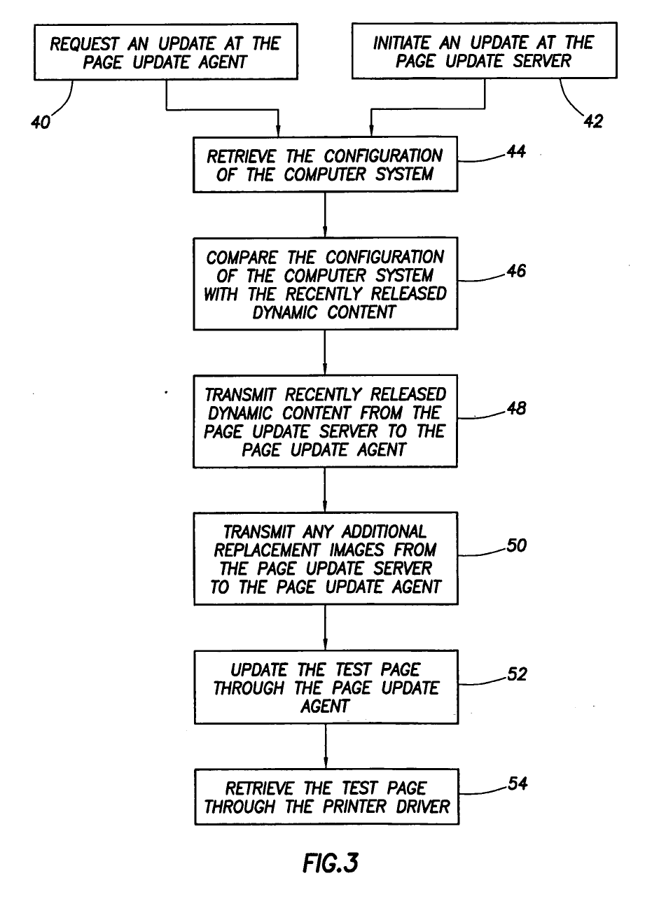

Shown in FIG. 3 is a flow diagram of a series of method steps for updating the test print page. An update of the test print page can be initiated by the page update agent of the computer system or by the remote page update server. These two options for initiating an update of the test print page are shown in FIG. 3. At step 40, the page update agent requests an update from the page update server. With respect to the frequency or timing of a request by the page update agent for a test print page update from the page update server, the page update agent can access the page update server and request an update (a) on a periodic basis, (b) in response to a prompt from the page update server, or (c) in response to an event in the computer system, such as when the remaining ink in the ink cartridge reaches a threshold level. Alternatively, at step 42, the page update server may access the page update agent to provide an update of the test print page. As an example, the page update server may contact the page update agent when the page update server has an item of dynamic content that is available to be provided to the page update agent for inclusion in the test print page.

At step 44, following the initiation or request for a page update, the page update server retrieves the configuration of the computer system. In some instances, the computer system will have a unique identifier. The page update server will use the unique identifier to retrieve the configuration of the computer system, including a listing of the components of the computer system. The configuration of the computer system may be the configuration of the computer system that existed at the time that the computer system was shipped to the customer, together with any additional components that have been subsequently ordered for the computer system since the shipment date.

At step 46, a comparison is made between the configuration of the computer system and the dynamic content available to be provided by the page update server as an update to the test print page of the page update server. As an example of updated dynamic content and comparison step 46, when a new product is introduced, such as a new monitor product, an image of the new product is made available to the page update server as dynamic content that can be provided to a computer system for inclusion in the test print page. As a further example, the test print page may include a slice of dynamic content that is devoted to the most recent monitor products of the computer manufacturer. Page update server will compare the monitor product that is included in the updated dynamic content slice to the monitor product that is installed in the customer's computer system. If the monitor product of the updated dynamic content slice is more recent than the customer's monitor product, the updated dynamic content slice will be provided to the page update agent at step 48. At step 50, a set of additional dynamic content updates may be provided by the page update server to the test print page. These additional dynamic content slices could include new corporate logos, new product offerings, or new product instructions for the computer system.

At step 52, the page update agent updates test print page 30 at the computer system. The test print page update process is done by replacing certain HTML slices of the test print page with the dynamic content provided by the page update server. The combination of the dynamic content and the static content forms the content of the test print page. At step 54, the test print page can be printed at the printer driver. When the test print page is printed, the most current set of dynamic content, including any dynamic content that was recently added to the test print page, is included in the test print page.

The method of FIG. 3 has been described with reference to a technique in which some, but not all, of the content of the test print page is updated. It should also be recognized that the system and method disclosed herein may be used to update the entire content of the test print page. In this manner, the entire content of the test print page would be updated, not just the content associated with certain dynamic portions of the test print page.

The system and method described herein provides a method for dynamically updating the content of a test print page so that the test print page includes at least some content that is current and meaningful to either the user or the manufacturer of the computer system. The ability to update the test print page of the computer system provides for updating a test print page through the use of HTML slices of dynamic content so that the test print page include both static content, which cannot be updated, and dynamic content, which can be updated.

The system and method of this disclosure has been described with reference to a computer system. It should be recognized, however, that this system could be used with any information handling system that includes a printer driver, a test print page, and access to a communications network for updating the test print page. Although the present disclosure has been described in detail, it should be understood that various changes, substitutions, and alterations can be made hereto without departing from the spirit and the scope of the invention as defined by the appended claims.

What is claimed is:

1. A method for updating the test print page of a computer system, comprising:
providing a test print page saved to nonvolatile memory of the computer system, wherein the printer driver of the computer system can access the test print page;
receiving at the computer system an update to the dynamic content of the test print page; and
updating the test print page by replacing at least some portion of the dynamic content with the update to the dynamic content received at the test print page.

2. The method for updating the test print page of a computer system of claim 1, wherein the dynamic content of the test print page comprises an HTML image.

3. The method for updating the test print page of a computer system of claim 1, wherein the dynamic content of the test print page comprises multiple HTML images, each of which can be updated independently.

4. The method for updating the test print page of a computer system of claim 1,
wherein the dynamic content of the test print page comprises multiple HTML images, each of which can be updated independently; and
wherein the update to the dynamic content is received from a remote server.

5. The method for updating the test print page of a computer system of claim 1, wherein the dynamic content of the test print page comprises multiple HTML images, each of which can be updated independently, and wherein the test print page includes static content.

6. The method for updating the test print page of a computer system of claim 1, wherein the step of receiving at the computer system an update to the dynamic content of the test print page comprises the steps of:
at the computer system, periodically requesting an update from a server computer; and
receiving at the computer system an update to the dynamic content of the test print page if it is determined that the test print page does not include the most recent dynamic content.

7. The method for updating the test print page of a computer system of claim 1, wherein the step of receiving at the computer system an update to the dynamic content of the test print page comprises the steps of:
at a remote server computer, comparing the configuration of the computer system to dynamic content at the remote server computer to determine if the test print page includes the most recent dynamic content for the configuration of the computer system; and
receiving at the computer system an update to the dynamic content of the test print page if it is determined that the test print page does not include the most recent dynamic content.

8. The method for updating the test print page of a computer system of claim 1, wherein the step of receiving at the computer system an update to the dynamic content of the test print page comprises the step of, at a remote server computer, transmitting to the computer system an update to the dynamic content of the test print page upon a determination that the test print page does not have the most recent dynamic content.

9. The method for updating the test print page of a computer system of claim 1, wherein the step of receiving at the computer system an update to the dynamic content of the test print page comprises the steps of:
at a remote server computer, comparing the configuration of the computer system to dynamic content at the remote server computer to determine if the test print page includes the most recent dynamic content for the configuration of the computer system; and
at a remote server computer, transmitting to the computer system an update to the dynamic content of the test print page upon a determination that the test print page does not have the most recent dynamic content for the configuration of the computer system.

10. The method for updating the test print page of a computer system of claim 1, wherein the step of updating the test print page by replacing at least some portion of the dynamic content with the update to the dynamic content received at the test print page comprises the step of updating the dynamic content of the test print page to reflect product offerings available to the user of the computer system.

11. A computer system, comprising:
nonvolatile memory,
a test print page saved to nonvolatile memory, wherein the test print page includes areas of content that can be modified;
a printer driver able to access the test print page; and
a test print page update program, wherein the test print page update program is operable to modify the modifiable areas of the test print page.

12. The computer system of claim 11, wherein the test print page includes areas of static content that cannot be modified.

13. The computer system of claim 11, wherein the test print page is coupled through a communications network to a server for receiving updates to the modifiable areas of the test print page.

14. The computer system of claim 11, wherein the test print page is coupled through the Internet to a server for receiving updates to the modifiable areas of the test print page.

15. The computer system of claim 11, wherein each modifiable area of the test print page comprises an HTML image.

16. The computer system of claim 11,
wherein the test print page includes areas of static content that cannot be modified;
wherein each modifiable area of the test print page comprises an RTWML image; and
wherein the test print page is coupled through a communications network to a server for receiving updates to the modifiable areas of the test print page.

17. A method for updating the content of a test print page in an information handling system, wherein the test print page includes modifiable content, comprising:
receiving at the information handling system an update to the modifiable content of the test print page; and
modifying the test print page to include the update to the modifiable content of the test print page.

18. The method for updating the content of a test print page in an information handling system of claim 17, wherein the update to the modifiable content is received at the information handling system from a remote server computer.

19. The method for updating the content of a test print page in an information handling system of claim 17, wherein the test print page includes static content that cannot be modified.

20. The method for updating the content of a test print page in an information handling system of claim 17, wherein the modifiable content of the test print page comprises HTML images.
